(19) United States
(12) Patent Application Publication
(10) Pub. No.: US 2002/0099705 A1
(43) Pub. Date: Jul. 25, 2002

(54) Simplified management of audio recording objects

(76) Inventors: Philip Campbell, Palo Alto, CA (US); Scott Silfvast, Palo Alto, CA (US); Paul deBenedictis, Menlo Park, CA (US)

Correspondence Address: CENTRAL COAST PATENT AGENCY, PO BOX 187, AROMAS, CA, 95004, US

(21) Appl. No.: 09/769,648

(22) Filed: Jan. 24, 2001

(51) Int. Cl. G06F 7/00

(52) U.S. Cl. 707/10

(57) ABSTRACT

A file-management utility for managing groupings of related electronic files is provided. The file management utility comprises, a graphical user interface executable from a computer workstation, the interface for enabling file identification and user-performed actions to be carried out on the files and a parent file represented within the interface and associated with at least one grouping of related electronic files, the parent file linked by common attribute to each electronic file comprising the grouping. A user operating the interface may manipulate the parent file represented within the interface thereby causing the effects of the manipulation to extend to designated ones of the associated files.

### FIELD OF THE INVENTION

The present invention it is in the field of digital recording, and has particular application in management of multiple digitally recorded files.

### BACKGROUND OF THE INVENTION

The production of electronic sounds by digital techniques is rapidly replacing the use of oscillators, synthesizers, and other analog audio components that have been the standard resources of the composer of electronic music. Not only is digital circuitry and digital programming much more versatile and accurate, but it is also much less expensive. The many advantages of digital processing are manifest even to the commercial recording industry, were digital recording is replacing long-established audio technology.

Perhaps the most important development in electronic music is the use of digital computers. The kinds of computers employed include large mainframe computers, general-purpose machines, special-purpose digital circuits expressly designed for musical uses, and increasingly, smaller digital workstations and personal computers. Of the several musical applications of digital computers, music composition, sound synthesis, and recording is perhaps the most widespread and advanced activity attracting considerable research and experimentation.

Increasingly, attention has been given to all aspects of computer processing of music, including composition, sound analysis and synthesis, recording and graphics. For example, there is a growing interest in analog-to-digital conversion as a musical compositional tool allowing recorded sounds to be subjected to digital processing by the computer utilizing software synthesis. Digital workstations and personal computers are also used to record music or sound tracks, and have become the foundation that many smaller digital recording studios are built upon. Such a system, in addition to a computer having display, input, storage and other common computer devices, has an interface allowing input of signals into the system for digital recording or processing, as well as signal output to an appropriate playback for monitoring device, for example. Various software applications are also often utilized in such a computer-based system, applications providing, for example, digital recording capability and digital representation of recorded sound that can then be manipulated using various techniques, including filtering, time delay, frequency shifting and so on. Other software applications may allow a musician, working with a specific recorded music track, to add an additional recording track, thereby creating an additional file to be stored in the computer's storage device.

It is often the case, even for smaller, simpler recording sessions, that a great number of separate files result, representing the multiple recorded sound tracks, as well as quite possibly a variety of additional annotation files, each containing notes about different sound tracks, for example. Such a system utilizing digital recording and synthesis software as described can allow many different musicians or sound technicians to retrieve and manipulate specific existing sound track files, which are often, to provide ease of accessibility, stored in a centralized file folder or group of file folders within the computer hard drive. The user may also add additional sound tracks or annotation files to an existing grouping of files, or record a new session creating a completely new grouping of sound tracks and annotation files.

Certain problems are presented, however, by utilizing such a computer-based digital recording and file storage system. A vast number of files are eventually created as a result of many different recording sessions, sound track edits and annotations over an extended period of time, and categorization and effective management of such a multitude of files becomes increasingly difficult. Having a logical grouping of files is especially important when, for instance, a musician, after assembling a grouping of recording objects, previously recorded audio tracks and annotations for example, wishes to transfer the files to a removable storage disk for transport to another studio for use in another session. The musician may wish to search for the desired files using the criteria of some commonly-noted attributes or annotations to the files, such as similar filenames or extensions, file creation date, and so on. Finding, retrieving, copying and moving of only the correct files, out of a possible multitude of files to choose from, and searching based only on such common information may be a very cumbersome and time-consuming process for many users. This is the particularly true for those not adept in the processes and procedures involved. The unwanted inclusion, alteration, damage or loss of some files by the inexperienced or inattentive user is also a distinct possibility in such a dense and confusing file storage environment, a storage environment common in conventional computer systems. In other cases, the file or grouping of files to be transported may be a sub file of a large streaming audio file containing multiple songs, for example, thereby creating a further problem, presented by the difficulty in separating out the specific files comprising a song or song segment.

What is clearly needed are a method and system allowing a user to logically and simplistically manage, categorize and perform functions upon entire groups of associated audio recording files. What is also needed is a method for separating a streaming audio file into multiple separate files, providing also the capability to consolidate and send multiple separate files into a streaming audio file.

### SUMMARY OF THE INVENTION

In a preferred embodiment of the present invention, a file-management utility for managing groupings of related electronic files is provided. The file management utility comprises, a graphical user interface executable from a computer workstation, the interface for enabling file identification and user-performed actions to be carried out on the files and a parent file represented within the interface and associated with at least one grouping of related electronic files, the parent file linked by common attribute to each electronic file comprising the grouping. A user operating the interface may manipulate the parent file represented within the interface thereby causing the effects of the manipulation to extend to designated ones of the associated files.

The electronic files are, in a preferred embodiment, recording objects stored in a digital storage facility accessible to the workstation. In this aspect, the recording objects include those that are sound files, those that are annotation files, and those that are graphics files.

In one aspect of the present invention, the file-management utility further comprises a component having file creation, playback, and edit capabilities. In this aspect, files created in association with a same project or portion thereof are automatically identified to each other and to the parent file.

In one aspect of the present invention, the file-management utility further comprises, one or more additional parent files linked to one or more additional file groupings, wherein manipulation of any one or a combination of the parent files is extended to the appropriate associated file groups. In this aspect, manipulation of parent files includes the actions move, copy, paste, and sort.

In yet another aspect of the present invention, a system for managing electronic files is provided. The system comprises, a computer workstation having a display monitor and input mechanism, a file-management utility executable from the workstation, a graphical user interface of the utility launched through execution of the utility, the interface for enabling file identification and user-performed actions to be carried out on the electronic files, a parent file represented within the interface and associated with at least one grouping of related electronic files, the parent file linked by common attribute to each electronic file comprising the grouping and a digital storage facility accessible to the computer workstation, the storage facility for storing the electronic files and the parent files.

The electronic files are, in a preferred aspect, recording objects stored in the digital storage facility accessible to the workstation. In this aspect, the recording objects include those that are sound files, those that are annotation files, and those that are graphics files.

In another aspect, the system further comprises a playback component executable through the utility, the component having file creation, playback, and edit capabilities. In this aspect, files created in association with a same project or portion thereof are automatically identified to each other and to the parent file.

In still another aspect, the system further comprises, one or more additional parent files represented within the interface, the parent files linked to one or more additional file groupings, wherein manipulation of any one or a combination of the parent files is extended to the appropriate associated file groups. In all practical aspects, the above-mentioned workstation is one of a personal computer, a dedicated digital studio, or a notebook computer.

In a digital editing system, a method for manipulating, through a single interface a plurality of electronic files through interaction with a single parent file represented within the interface, the parent file linked to each of the plurality of electronic files is provided. The method includes the steps of, (a) executing the interface to display on suitable display apparatus of the editing system, (b) selecting the parent file represented within the interface and (c) initiating a file action to the parent file, the file action automatically extended to the plurality of electronic files.

In one aspect of the method in step (a), the editing system is one of a personal computer, a dedicated digital studio, or a notebook computer. In a preferred application in step (b), the parent file is linked to the plurality of electronic files through a common attribute of all of the files. Also in preferred application in step (c), the electronic files are recording objects created during a digital recording project. Also, in step (c), the recording objects include sound files, annotation files, and graphics files. In this aspect, the file actions include copy, move, paste, and sort.

Now, for the first time, a method and system is provided which allows a user to logically and simplistically manage, categorize and perform functions upon entire groups of associated audio recording files. Additionally, a method for separating a streaming audio file into multiple separate files is also provided.

### BRIEF DESCRIPTION OF THE DRAWING FIGURES

FIG. 1 is a simplified diagram of a conventional computer-based digital recording system.

FIG. 2 is a simplified diagram of a computer display showing a conventional file-management software tool.

FIG. 3 is a simplified block diagram of a file management tool according to a preferred embodiment of the present invention.

FIG. 4 is a simplified diagram of a file grouping method according to an alternative embodiment of the present invention.

FIG. 5 is a simplified block diagram of a computer display showing a standard file management tool for managing recording objects according to another alternative embodiment of the present invention.

### DESCRIPTION OF THE PREFERRED EMBODIMENTS

As previously described in the background section, the composition and recording of music and audio tracks by digital means is rapidly becoming a method of choice for those in the music industry as well as average users. Digital recording provides higher-fidelity sound reproduction than does ordinary recording methods, largely because audio signals converted into simple pulse patterns are virtually immune to the residual noise and distortion that are a characteristic of analog communication channels and sound recording media. In addition, many digital recording systems are designed to detect and eliminate interfering signals.

A typical digital recording system is equipped with an analog-to-digital converter that transforms two channels of continuous audio signals into digital information, which can then be recorded and stored for future retrieval, editing, annotating, and so on. The use of smaller digital workstations or personal computers is becoming increasingly popular as the main object of such digital recording systems, due to the flexibility and ease-of-use provided, in addition to a relative low cost of purchase and maintenance. In addition to providing enhanced digital recording capabilities, other musical applications are also possible using a digital computer-based recording system, such as data-processing and information retrieval, including library applications and abstracting; processing of music notation and music printing; acoustical, theoretical, and musicological research; music composition; and sound synthesis. It is for these reasons that such computer-based digital recording systems are gaining much popularity, and that research and experimentation in the fields stated above are increasingly being carried out.

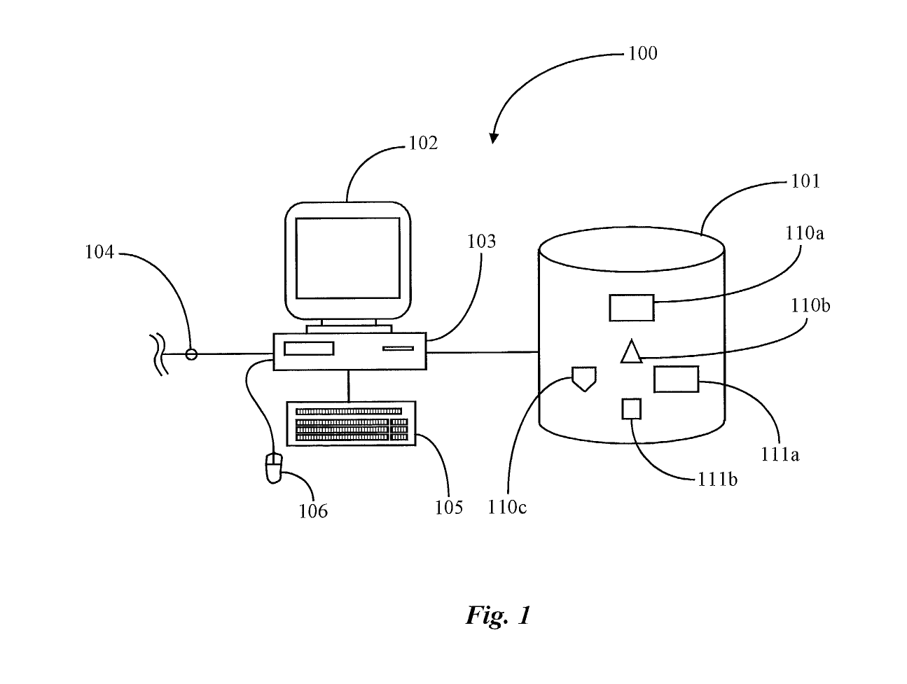

FIG. 1 is simplified diagram of a conventional computer-based digital recording system. Digital recording system 100 has a storage unit 101, which may be a large-capacity hard disk storage device, for example, designed for the purpose of storing recording objects created by digital music composition or related activities. A personal computer is shown in this view having a display monitor 102, main unit 103 housing the computer's internal hardware, a keyboard 105 used as an input device for user interface, and a mouse 106 used as the cursor pointing device; all components found in a typical personal computer system. A generic recording input/output interface 104, possibly incorporating analog-to-digital conversion processes, for example, allows for digital input of recorded music or sound tracks into the system, as well as providing the means for signal output from the system to an appropriate playback device. The source of the input signals to system 100 and any apparatus used for playback of output signals are not shown here, as they are not relevant to embodiments of the present invention. In this greatly simplified representation, several recording files, or objects, as they are subsequently referred to for reasons of uniformity herein, are shown to be stored together within storage unit 101. In a typical digital recording storage system, separate recording objects often can be separate sound tracks of different instruments or vocals, a combination of a plurality of related recording tracks, or may also be annotation files related to specific recording objects, and so on. In this representation recording objects 110a, 110b and 110c belong to one recording, and recording objects 111a and 111b belong to a different recording. For example, recording object 110a may be a separate recorded soundtrack of a guitar sequence recorded by a musician outside of the recording system described, and sent from the recording studio to the recording artist or composer, for the purpose of inclusion into an existing grouping of recording objects representing a previously recorded song needing an additional guitar track. Recording object 110b may be, for example, an annotation file containing notes written by the remote musician pertaining to recording object 110a, and recording object 110c may be a file containing tracks previously recorded by the artist or composer utilizing system 100. Other combinations of recording objects are obviously possible, including, for example, a series of objects that are various encryptions of the same sound, etc. In a typical computer-based digital recording system such as described herein, a broad variety of such recording objects or other files can be found, but for reasons of simplicity, only those pertinent to this explanation are shown.

It is often the case that a recording artist or musician will record different tracks creating various recording objects, utilizing a PC-based digital recording system such as described, to be included with tracks pre-recorded in another session by different musicians at a different studio utilizing separate digital recording and file storage systems. In order to accomplish this, the musician must first assemble and retrieve the correct recording objects which can then be transferred to a mobile file-storage system such as a removable hard disk storage medium or some similar apparatus, for physical transport to another studio; or recording objects can be then sent to the different studio by some other means such as a file transfer or over the Internet or local network, for example. Using the user interface devices previously described for system 100, the musician then activates a conventional file management software tool that displays, on display monitor 102, the files in storage from which to choose from.

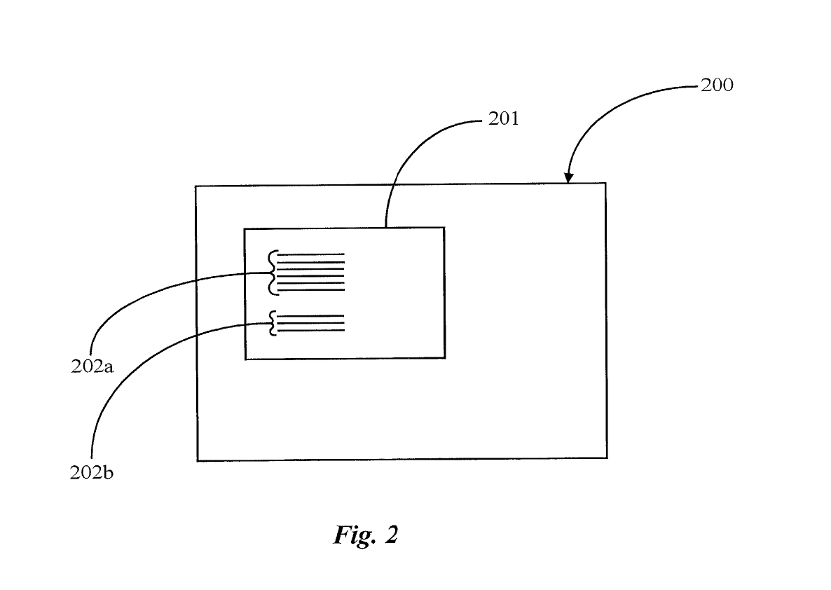

FIG. 2 is a simplified diagram of a computer display showing such a conventional file management software tool. Screen 200 is a simple representation of a display area of a typical display monitor such as display monitor 102 of FIG. 1. According to conventional methods the musician wishing to retrieve the correct recording objects as previously mentioned will use such a display device to view a window 201 which represents a conventional file management software tool, such as that used with an operating system of a typical personal computer or workstation. In this example, when the musician launches a file management software tool, two groups of files appear in window 201, namely file groups 202a and 202b. It is in this display window that the musician can now attempt to perform the necessary functions on the file groups in order to achieve the intended goal of transferring the correct files to the new studio location.

In this transfer process great care must be taken to ensure all of the desired files, and only the desired files, are copied when the attempt is made. As in many conventional file storage and retrieval systems such as described for a typical personal computer operating system, each of the files in file groups 202a and 202b have certain attributes such as filename, file creation date, filename extension, and so on. It is often the case that when viewing the software icons representing the files from which choose, certain attributes of those files are not readily visible, particularly creation date or file description, for example, unless an alternative viewing mode is invoked. However, certain attributes such as file description, for example, are still not visible even after invoking such an alternative-viewing mode in window 201. Because of this it is often quite difficult for many users, using a conventional file management tool as such, to group all of the correct files into one easy-to-manage set, and therefore the damage or loss of some files is a distinct possibility, especially for inexperienced or inattentive users. There is also a possibility that some files destined for the file set to be transferred may be forgotten or inadvertently omitted, and confusion can be created if some files that are not part of the intended set are inadvertently copied and included. In other situations files to be included in the intended set, a particular song or segment thereof, for example, are part of a larger streaming audio file containing multiple songs. There is no simplified way in conventional art to apportion such a large file into separate distinct files, each containing one song or segment.

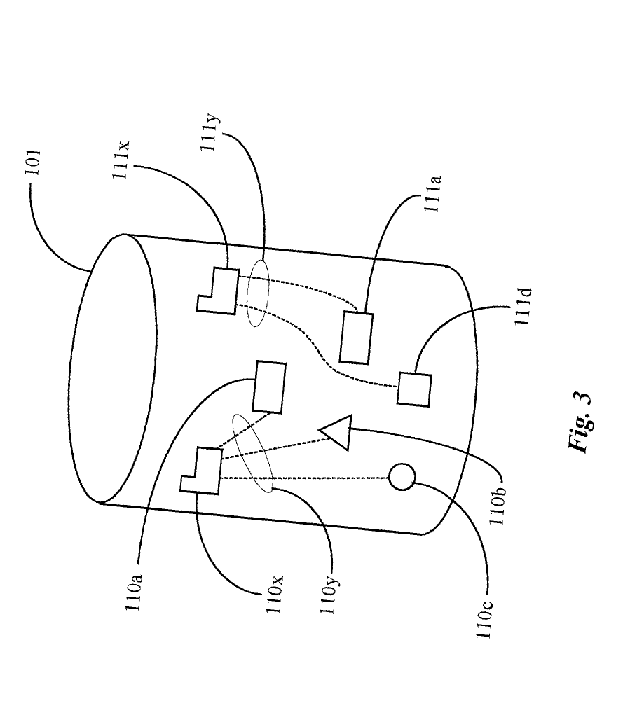

FIG. 3 is a simplified block diagram of a file management tool according to a preferred embodiment of the present invention. An improved method is taught in this embodiment allowing a user to easily and safely manage multiple associated recording objects.

In FIG. 3, file storage unit 101 of FIG. 1 is also shown, being a conventional computer file storage system, such as a hard disk storage device, for example. Recording objects 110a, 110b, and 110c, as well as objects 111a and 111b are also shown in this view as stored within storage unit 101, as in FIG. 1. Objects 110x and 111x are provided in this embodiment as super objects providing a means for easier and simpler management of all recording objects associated with each particular super object.

In this example, object 110x is linked through various attributes to recording objects 110a, 110b, and 110c, and object 111x is similarly linked to the recording objects 111a and 111d. Dotted line groups 110y and 111y are provided in this representation to symbolically link objects 110x and 111x to their associated recording objects. The link between a super object such as object 110x and its associated recording objects can be created, for example, by having a subdirectory inside object 110x containing the names, or other uniquely identifying attributes, of all the recording objects that belong to super object 110x. Likewise, object 111x may have a subdirectory containing the specific attributes of all or recording objects that long to super object 111x.

By creating links 110y and 111y it is now possible for the user to simply and easily manipulate all of the related recording objects in a particular set by manipulating just the linked super object. For example, to perform an action command, such as copying or moving, on all of the recording objects belonging to a particular set, for instance recording objects 110a, 110b and 110c, the action now only needs to be performed once on super object 110x. Upon invoking this action on super object 110x, the same action is automatically invoked upon linked recording objects 110a, 110b and 110c. Utilizing such a new and novel approach it is now possible for the user to manipulate all of the recording objects in one set by manipulating just one super object. A super object such as 110x or 111x can be referred to as an album, a master file, or some other encompassing signification, and automatically moves along with all of the recording objects indexed within it, for example, if the associated recording objects are moved as a group from one directory to another within storage unit 101. Besides the above mentioned manipulations, other commands, conversions, compression, decompression etc. may also be invoked for all files with a single click.

In some cases, for example, all related recording objects could be embedded into a single file or super object, and a software tool could be utilized to parse the single file into individual recording objects enabling each object to then be handled or manipulated separately. In other cases, each recording object could remain as a separate file, loosely connected by either a super object or a naming convention, as is described below in greater detail, and could be managed separately. The distinct difference between the two cases described is, if the associated recording objects are embedded within a single super object they are stored in storage unit 101 and manipulated as only one file, whereas recording objects linked to a super object remain as separate files.

In embodiments of the present invention, even when recording objects are embedded within super objects, each recording object can exist in its own data format as previously created, and is stored in storage device 101 as a single file. In still other cases, multiple recorded tracks or songs may exist in the form of a single streaming audio file, either by itself or embedded within a video stream along with a combination of other graphics or text, as is possible with such a format. Such files, after being sent by various means from one studio to another, for example, are first received at the destination, then sectioned, either manually or automatically, into distinct files that can then be saved to the storage destination as separate files, or as an album file, or both. In some other cases when sending and receiving files, an album or a set of files is sent as a single streaming audio file to facilitate simple streaming of multiple files.

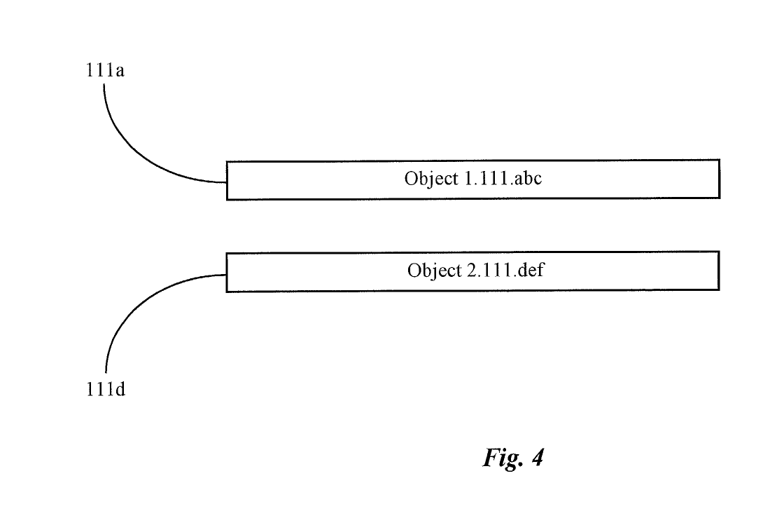

In another aspect of the present invention an additional method is provided for easily and logically grouping recording objects together to facilitate quicker, more accurate and efficient file management and actioning. FIG. 4 is a simplified diagram of such a file grouping method according to an alternative embodiment of the present invention. Recording objects 111a and 111b in storage unit 101 of FIG. 1 are shown in the example presented in FIG. 4, and the file names for both recording objects are shown respectively. In each filename an identifier “111” has been introduced and inserted between the actual filename, in this case “Object 1” for recording object 111a, and “Object 2” for recording object 111d, and the filename extensions which are “.abc” and “.def” respectively. In some cases, the identifier could be inserted between the filename and an existing extension. The purpose of the identifier is to provide a relationship between all of the recording objects, with file names containing like identifiers, to each other so that, by referencing the identifier a special software editing tool would be able to correctly group all of the associated recording objects into one set. A key advantage provided by grouping recording objects in this manner is that, as new objects are created to be associated with a particular session that has been previously recorded and saved using file names with identifiers introduced as described above, the new objects with filename identifiers introduced are automatically linked, by way of the filename identifier, to the existing associated recording objects, requiring no further changes to the attributes of any of the existing associated objects in storage.

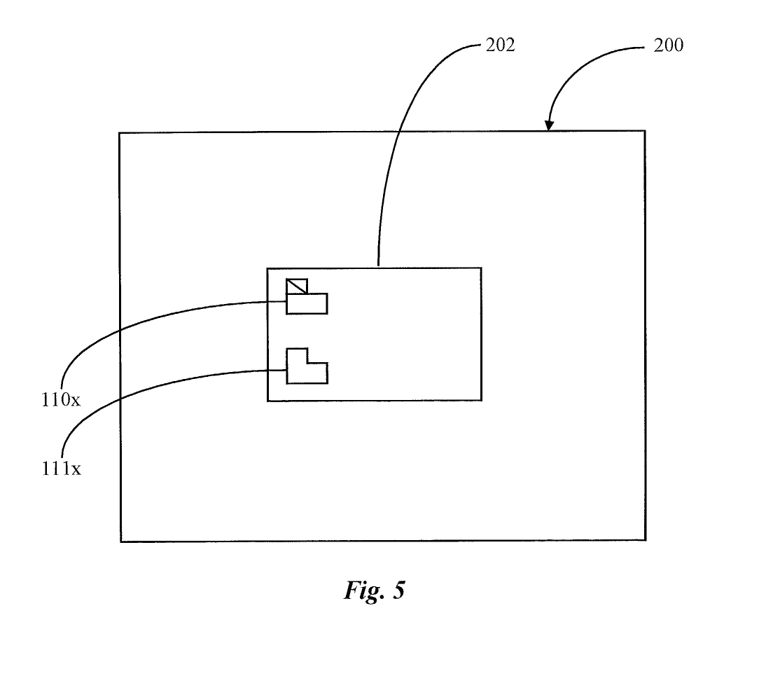

FIG. 5 is a simplified block diagram of a computer display showing a file management tool according to another alternative embodiment of the present invention. Display screen 200 of display monitor 102 of FIG. 1 is shown in this view displaying a window 202, which, in this example represents the editing view of a file management system containing the super objects 110x and 111x of storage unit 101 of FIG. 3. In this embodiment, super objects 110x and 111x contain all of the associated recording objects of their respective sets. By manipulating a super object such as described above, all of the associated recording objects contained within the master object are manipulated in the same manner. For example, if a user executes a file command (or any other command) such as copy, cut or move, for example, on the super object, the same command is automatically executed on all of the associated recording objects associated by the super object. In some cases, instead of using a standard file manager to act upon the super objects and their associated recording objects, a special software tool can be alternatively used that will display only the super object, and when a command is executed upon the super object, all of the associated objects associated by the super object are identically acted upon, but are not displayed, which eliminates visual redundancy.

In different variations of the embodiments described above an enveloping security wrapper may be incorporated, useful when transporting files on a network such as an Intranet or over the Internet, where not all users are authorized to access the files. Such a security wrapper may be a simple envelope that in some cases only adds a checksum, and in some other cases data compression or encryption, password protection or some other known security measure can be applied. In some cases any combination of the above security features may be offered, being completely transparent to the user of the application. For example, the user can transparently gain access to all files in all situations, whether sent through a local network or contained on network servers, by simply logging into the application, and by logging in, providing identification as an authorized user, thereby eliminating the need to repeatedly log in for different applications. In other cases different levels of security can be assigned to specific users. For example, a user, when opening a file belonging to another user such as the originating artist, for example, may need to enter a password known only by a predefined group of users, a “public” password which, in some cases, may give a user only limited access to the file. For instance, such a password may only provide a user read-only capability, that is, capability to only be able to play the file and not make any changes or execute any other commands on the file. At another level, the user may be allowed to rearrange sections within the file, but not to add to or modify parts of it.

It will be apparent to the skilled artisan that the examples presented herein as embodiments of the present invention are greatly simplified, and in real cases there can be many more elements than those described. Only those elements necessary to explain, in enabling detail, the embodiments of the invention are shown. The simple diagrams, however, presented herein are sufficient to describe the system and practice of the present invention, and for these reasons must be accorded the breadth of the claims, which follow:

What is claimed is:

1. A file-management utility for managing groupings of related electronic files comprising:
a graphical user interface executable from a computer workstation, the interface for enabling file identification and user-performed actions to be carried out on the files; and
a parent file represented within the interface and associated with at least one grouping of related electronic files, the parent file linked by common attribute to each electronic file comprising the grouping;
characterized in that a user operating the interface may manipulate the parent file represented within the interface thereby causing the effects of the manipulation to extend to designated ones of the associated files.

2. The file-management utility of claim 1, wherein the electronic files are recording objects stored in a digital storage facility accessible to the workstation.

3. The file-management utility of claim 2, wherein the recording objects include those that are sound files, those that are annotation files, and those that are graphics files.

4. The file-management utility of claim 3 further comprising a playback component having file creation, playback, and edit capabilities.

5. The file-management utility of claim 4, wherein files created in association with a same project or portion thereof are automatically identified to each other and to the parent file.

6. The file-management utility of claim 5 further comprising:
one or more additional parent files linked to one or more additional file groupings, wherein manipulation of any one or a combination of the parent files is extended to the appropriate associated file groups.

7. The file-management utility of claim 6, wherein manipulation of parent files includes the actions move, copy, paste, and sort.

8. A system for managing electronic files comprising:
a computer workstation having a display monitor and input mechanism;
a file-management utility executable from the workstation;
a graphical user interface of the utility launched through execution of the utility, the interface for enabling file identification and user-performed actions to be carried out on the electronic files;
a parent file represented within the interface and associated with at least one grouping of related electronic files, the parent file linked by common attribute to each electronic file comprising the grouping; and
a digital storage facility accessible to the computer workstation, the storage facility for storing the electronic files and the parent files.

9. The system of claim 8, wherein the electronic files are recording objects stored in the digital storage facility accessible to the workstation.

10. The system of claim 9, wherein the recording objects include those that are sound files, those that are annotation files, and those that are graphics files.

11. The system of claim 10 further comprising a playback component executable through the utility, the component having file creation, playback, and edit capabilities.

12. The system of claim 11, wherein files created in association with a same project or portion thereof are automatically identified to each other and to the parent file.

13. The system of claim 12 further comprising:
one or more additional parent files represented within the interface, the parent files linked to one or more additional file groupings, wherein manipulation of any one or a combination of the parent files is extended to the appropriate associated file groups.

14. The system of claim 13, wherein the workstation is one of a personal computer, a dedicated digital studio, or a notebook computer.

15. In a digital editing system, a method for manipulating, through a single interface a plurality of electronic files through interaction with a single parent file represented within the interface, the parent file linked to each of the plurality of electronic files comprising the steps of:
(a) executing the interface to display on suitable display apparatus of the editing system;
(b) selecting the parent file represented within the interface; and
(c) initiating a file action to the parent file, the file action automatically extended to the plurality of electronic files.

16. The method of claim 15 wherein in step (a), the editing system is one of a personal computer, a dedicated digital studio, or a notebook computer.

17. The method of claim 16 wherein in step (b), the parent file is linked to the plurality of electronic files through a common attribute of all of the files.

18. The method of claim 17 wherein in step (c), the electronic files are recording objects created during a digital recording project.

19. The method of claim 18 wherein in step (c), the recording objects include sound files, annotation files, and graphics files.

20. The method of claim 19 wherein in step (c), the file actions include copy, move, paste, and sort.
